(19) United States
(12) Patent Application Publication
(10) Pub. No.: US 2026/0198478 A1
(43) Pub. Date: Jul. 16, 2026

(54) Vision Based System and Methods for Targeted Spray Actuation

(71) Applicant: Precision Planting LLC, Tremont, IL (US)

(72) Inventors: Michael Strnad, Delavan, IL (US); Jason J. Stoller, Eureka, IL (US)

(21) Appl. No.: 19/136,709

(22) PCT Filed: Nov. 27, 2023
(86) PCT No.: PCT/IB2023/061920

§ 371 Date: Jun. 6, 2025

Related U.S. Application Data
(60) Provisional application No. 63/386,244, filed on Dec. 6, 2022.
(60) Provisional application No. 63/386,241, filed on Dec. 6, 2022.

(51) Int. Cl. A01M 21/04; G06V 10/147; G06V 10/774; G06V 10/82; G06V 20/10

(52) U.S. Cl. CPC A01M 21/043; G06V 10/147; G06V 10/774; G06V 10/82; G06V 20/188

(57) ABSTRACT

A computer implemented method including: capturing, with a first image sensor of a camera that is disposed on an implement, a first sequence of images while the implement travels through an agricultural field; capturing, with a second image sensor of the camera, a second sequence of images while the implement travels through the agricultural field; training a neural network (NN) model with image data from at least one channel of the first image sensor and one channel of the second image sensor; and providing weed size as NN training target output channel.

### CROSS REFERENCE TO RELATED APPLICATIONS

This application claims priority to U.S. Application Nos. 63/386241, filed 6 Dec. 2022, and 63/386244, filed 6 Dec. 2022, all of which are incorporated herein by reference in their entireties.

### BACKGROUND

Sprayers and other fluid application systems are used to apply fluids (such as fertilizer, herbicide, insecticide, and/or fungicide) to fields. Cameras located on the sprayers can capture images of the spray pattern, weeds, and plants growing in an agricultural field. Sprayers can apply too much fluid resulting in additional cost of fluid materials or not enough fluid resulting in weeds or diseases being able to continue spreading and reducing crop yield.

### BRIEF DESCRIPTION OF THE DRAWINGS

FIG. 1 is an illustration of an agricultural crop sprayer.

FIG. 2 is a rear elevation view of a spray boom with cameras according to one embodiment.

FIG. 3 is a rear elevation view of a spray boom with cameras according to another embodiment.

FIGS. 4A-4B illustrate a flow diagram of one embodiment for a computer-implemented method of using images captured by a vision based system to apply fluids (e.g., fertilizer, herbicide, insecticide, and/or fungicide, etc.) in a targeted manner to fields.

FIGS. 5A-5B show illustrations for displaying maps for weed metrics in accordance with one embodiment.

FIG. 6 illustrates an exemplary camera 70 with lenses 351 and 352.

FIG. 7 illustrates a camera 70 that includes an image sensor 356 for lens 355 and an image sensor 372 for lens 370 in accordance with some embodiments.

FIG. 8 illustrates a flow diagram of one embodiment for a computer-implemented method of using a neural network (NN) model to determine weed size from images captured by multiple image sensors of a vision based system to apply fluids (e.g., fertilizer, herbicide, insecticide, and/or fungicide, etc.) in a targeted manner to fields.

FIG. 9A shows an example of a block diagram of a self-propelled implement 140 (e.g., sprayer, spreader, irrigation implement, etc.) in accordance with one embodiment.

FIG. 9B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

### BRIEF SUMMARY

In an aspect of the disclosure there is provided a system comprising a boom, a plurality of nozzles disposed along the boom to apply a fluid application as the boom travels through an agricultural field, at least one camera disposed on the boom to capture images of the agricultural field including a target region, and a processor communicatively coupled to the at least one camera. The processor is configured to determine a weed density for the target region and whether one or more weeds are located at an evaluation point within the target region based on one or more images of the target region, and to determine a spray actuation plan on a per nozzle basis for the target region based on whether the weed density for the target region equals or exceeds a threshold weed density and whether one or more weeds are located at the evaluation point within the target region.

In one example of the system, wherein the processor is further configured to perform the spray actuation plan if the weed density equals or exceeds the threshold weed density for the target region or if one or more weeds are located at the evaluation point.

In one example of the system, wherein the processor is further configured to perform the spray actuation plan by applying fluid with the nozzles that pass over the target region when the weed density reaches a threshold weed density for the target region.

In one example of the system, wherein the processor is further configured to perform the spray actuation plan and determine a number of nozzles to apply fluid when passing over the target region based on the determined weed density.

In one example of the system, wherein the processor is further configured to perform the spray actuation plan and determine a first fluid rate for a minimum first weed density, a second fluid rate for a second weed density, and a third fluid rate for a third weed density.

In one example of the system, wherein the processor is further configured to perform the spray actuation plan when the weed density is below the threshold weed density and detection of one or more weeds at an evaluation point.

In one example of the system, wherein the spray actuation plan to cause application of the fluid with a nozzle that passes over the evaluation point plus additional adjacent nozzles to provide a spray pattern for a configurable lateral width that is laterally spaced from the one or more weeds within the evaluation point.

In one example of the system, wherein a number of nozzles that are activated to apply fluid when passing over the evaluation point is based on one or more of a number a weeds, a type of weed, and a weed size within the evaluation point.

In one example of the system, wherein the processor is further configured to determine a weed confidence metric for weed density and a weed detection confidence map for detection of individual weeds in real time as the boom travels through a field.

In one example of the system, further comprising a display device coupled to the processor. The display device is configured to display a weed confidence metric and weed detection confidence map.

In an aspect of the disclosure, there is provided a computer-implemented method comprising initiating a software application for a fluid application of an implement, receiving a sequence of images that are captured with a camera disposed on the implement while the implement travels through an agricultural field, determining a weed density for a target region based on one or more captured images of the target region, determining whether one or more weeds are located at an evaluation point within the target region based on one or more images of the evaluation point, and determining a spray actuation plan on a per nozzle basis for the target region based on whether the weed density for the target region reaches a threshold weed density and whether one or more weeds are located at the evaluation point within the target region.

In one example of the computer-implemented method, further comprising performing the spray actuation plan if the weed density reaches a threshold weed density for the target region or if one or more weeds are located at the evaluation point.

In one example of the computer-implemented method, further comprising performing the spray actuation plan by applying fluid with the nozzles that pass over the target region when the weed density equals or exceeds the threshold weed density for the target region.

In one example of the computer-implemented method, further comprising performing the spray actuation plan and determining a number of nozzles to apply fluid when passing over the target region based on the determined weed density.

In one example of the computer-implemented method, further comprising performing the spray actuation plan and determining a first fluid rate for a minimum first weed density, a second fluid rate for a second weed density, and a third fluid rate for a third weed density.

In one example of the computer-implemented method, further comprising performing the spray actuation plan when the weed density is below the threshold weed density and detection of one or more weeds at an evaluation point.

In one example of the computer-implemented method, wherein the spray actuation plan to cause application of the fluid with a nozzle that passes over the evaluation point plus additional adjacent nozzles to provide a spray pattern for a configurable lateral width that is laterally spaced from the one or more weeds within the evaluation point.

In one example of the computer-implemented method, wherein a number of nozzles that are activated to apply fluid when passing over the evaluation point is based on one or more of a number a weeds, a type of weed, and a weed size within the evaluation point.

In one example of the computer-implemented method, further comprising determining a weed confidence metric for weed density and a weed detection confidence map for detection of individual weeds in real time as the implement travels through a field in parallel with rows of plants.

In one example of the computer-implemented method, further comprising displaying a weed confidence metric for weed density and a weed detection confidence map for detection of individual weeds in real time as the implement travels through a field in parallel with rows of plants.

In another aspect of the disclosure, there is provided a computer implemented method comprising capturing, with a first image sensor of a camera that is disposed on an implement, a first sequence of images while the implement travels through an agricultural field, capturing, with a second image sensor of the camera, a second sequence of images while the implement travels through the agricultural field, training a neural network (NN) model with image data from at least one channel of the first image sensor and one channel of the second image sensor, and including weed size as NN training target output channel.

In one example of the computer-implemented method, wherein the NN model is trained with image data from a red channel, a blue channel, and a green channel of the first image sensor and one infrared (IR) channel of the second image sensor.

In one example of the computer-implemented method, further comprising providing the weed size as an input for the NN model during training.

In one example of the computer-implemented method, wherein a height of a full resolution stereo disparity image is used to determine a training target size for weeds, generated without specific classification by annotation.

In one example of the computer-implemented method, wherein the weed size is determined by annotators assigning a weed size to weeds during annotation.

In one example of the computer-implemented method, further comprising assigning the weed size for each weed detected in captured images to one of a plurality of buckets for two or more weed buckets of different sizes.

In one example of the computer-implemented method, further comprising determining a spray actuation plan on a per nozzle basis for the target region based on the weed size as determined by the NN model.

In one example of the computer-implemented method, further comprising applying based on the spray actuation plan fluid from a fluid source to nozzles of the implement that pass over a target region with a fluid rate being determined based on the weed size.

In one example of the computer-implemented method, wherein the spray actuation of the nozzle is dynamically adjusted in real time based on weed size.

In one example of the computer-implemented method, wherein the camera is disposed to look ahead in a direction of travel of the implement or to look downwards.

In another aspect of the disclosure, there is provided a system comprising an agricultural implement, a camera having a first image sensor and a second image sensor that is disposed on the agricultural implement. The camera is configured to capture a first sequence of images with the first image sensor while the implement travels through an agricultural field and configured to capture a second sequence of images with the second image sensor while the implement travels through the agricultural field. Processing logic is configured to train a neural network (NN) model with image data from at least one channel of the first image sensor and one channel of the second image sensor and to include weed size as NN training target output channel.

In one example of the system, wherein the NN model is trained with image data from the at least one channel including a red channel, a blue channel, and a green channel of the first image sensor and the one channel including an infrared (IR) channel of the second image sensor.

In one example of the system, wherein the processing logic is configured to provide the weed size as an input for the NN model during training.

In one example of the system, wherein a height of a full resolution stereo disparity image is used to determine a training target size for weeds, generated without specific classification by annotation.

In one example of the system, wherein the weed size is determined by annotators assigning a weed size to weeds during annotation.

In one example of the system, wherein the processing logic is configured to assign the weed size for each weed detected in captured images to one of a plurality of buckets for two or more weed buckets of different sizes.

In one example of the system, wherein the processing logic is configured to determine a spray actuation plan on a per nozzle basis for the target region based on the weed size as determined by the NN model.

In one example of the system, further comprising a plurality of nozzles disposed on the agricultural implement to apply fluid based on the spray actuation plan from a fluid source to a target region of the agricultural field as the plurality of nozzles pass over the target region with a fluid rate being determined based on the weed size.

In one example of the system, wherein spray actuation of a nozzle of the plurality of nozzles is dynamically adjusted in real time based on weed size.

In one example of the system, wherein the camera is disposed to look ahead in a direction of travel of the implement or to look downwards.

### DETAILED DESCRIPTION

All references cited herein are incorporated herein in their entireties. If there is a conflict between a definition herein and in an incorporated reference, the definition herein shall control.

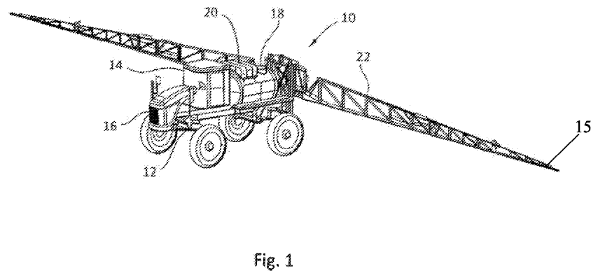

Referring to the drawings, wherein like reference numerals designate identical or corresponding parts throughout the several views, FIG. 1 illustrates an agricultural implement, such as a sprayer 10. While the system 15 can be used on a sprayer, the system can be used on any agricultural implement that is used to apply fluid to soil, such as a side-dress bar, a planter, a seeder, an irrigator, a center pivot irrigator, a tillage implement, a tractor, a cart, or a robot. A reference to boom or boom arm herein includes corresponding structures, such as a toolbar, in other agricultural implements.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g. mounted on a 3-point linkage of an agricultural tractor.

The sprayer 10 further comprises a liquid storage tank 18 used to store a spray liquid to be sprayed on the field. The spray liquid can include chemicals, such as but not limited to, herbicides, pesticides, and/or fertilizers. Liquid storage tank 18 is to be mounted on chassis 12, either in front of or behind cab 14. The crop sprayer 10 can include more than one storage tank 18 to store different chemicals to be sprayed on the field. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

At least one boom arm 22 on the sprayer 10 is used to distribute the fluid from the liquid tank 18 over a wide swath as the sprayer 10 is driven through the field. The boom arm 22 is provided as part of a spray applicator system 15 as illustrated in FIGS. 1-3, which further comprises an array of spray nozzles (in addition to lights, cameras, and processors described later) arranged along the length of the boom arm 22 and suitable sprayer plumbing used to connect the liquid storage tank 18 with the spray nozzles. The sprayer plumbing will be understood to comprise any suitable tubing or piping arranged for fluid communication on the sprayer 10. Boom arm 22 can be in sections to permit folding of the boom arm for transport.

Additional components that can be included, such as control modules or lights, are disclosed in PCT Publication No. WO2020/178663 and U.S. Application No. 63/050,314, filed 10 Jul. 2020, respectively.

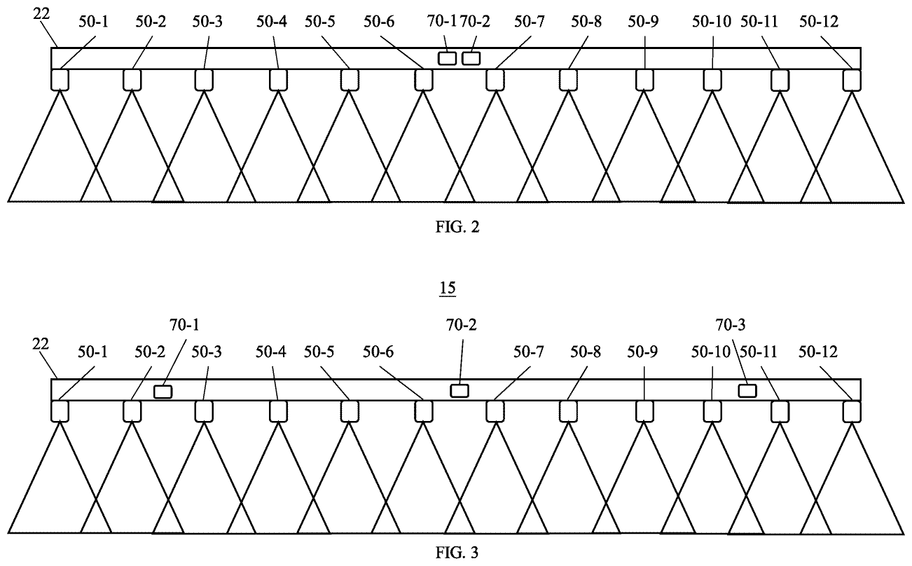

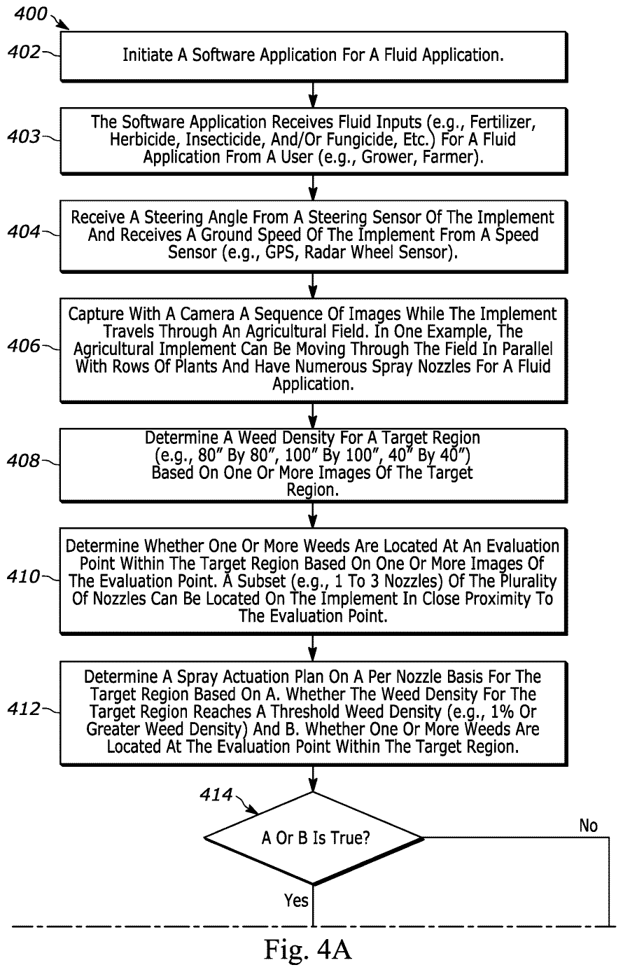

Illustrated in FIGS. 2 and 3, there are a plurality of nozzles 50 (50-1 to 50-12) disposed on boom arm 22. While illustrated with 12 nozzles 50, there can be any number of nozzles 50 disposed on boom arm 22. Nozzles 50 dispense material (such as fertilizer, herbicide, or pesticide) in a spray. In any of the embodiments, nozzles 50 can be actuated with a pulse width modulation (PWM) actuator to turn the nozzles 50 on and off. In one example, the PWM actuator drives to a specified position (e.g., full open position, full closed position) according to a pulse duration, which is a length of the signal.

Illustrated in FIG. 2, there are two cameras 70 (70-1 and 70-2) disposed on the boom arm 22 with each camera 70-1 and 70-2 disposed to view half of the boom arm 22. Illustrated in FIG. 3, there are a plurality of cameras 70 (70-1, 70-2, 70-3) each disposed on the boom arm 22 with each viewing a subsection of boom arm 22. While illustrated with three cameras 70, there can be additional cameras 70. In the plurality of camera 70 embodiments, the cameras 70 can each be disposed to view an equal number of nozzles 50 or any number of nozzles 50.

A combined camera 70 includes a light unit. A reference to camera 70 is to either a camera or camera/light unit unless otherwise specifically stated.

Camera 70 can be any type of camera. Examples of cameras include, but are not limited to, digital camera, line scan camera, monochrome, RGB (red, green blue), NIR (near infrared), SWIR (short wave infrared), MWIR (medium wave infrared), LWIR (long wave infrared), optical sensor (including receiver or transmitter/receiver), reflectance sensor, laser.

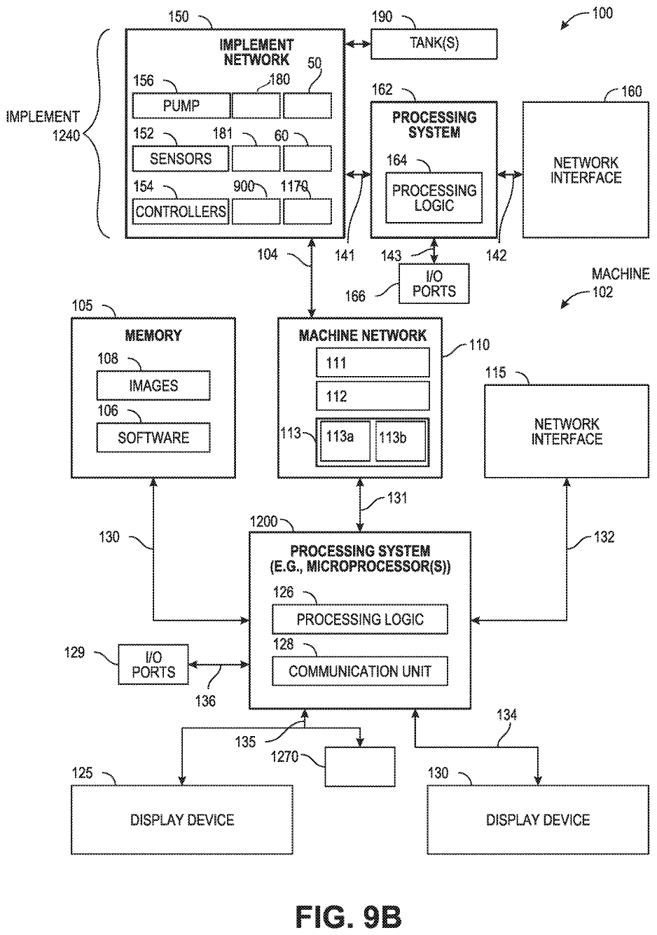

In one embodiment, nozzles 50and cameras 70 are connected to a network. An example of a network is described in PCT Publication No. WO2020/039295A1 and is illustrated as implement network 150 in FIG. 9A and FIG. 9B.

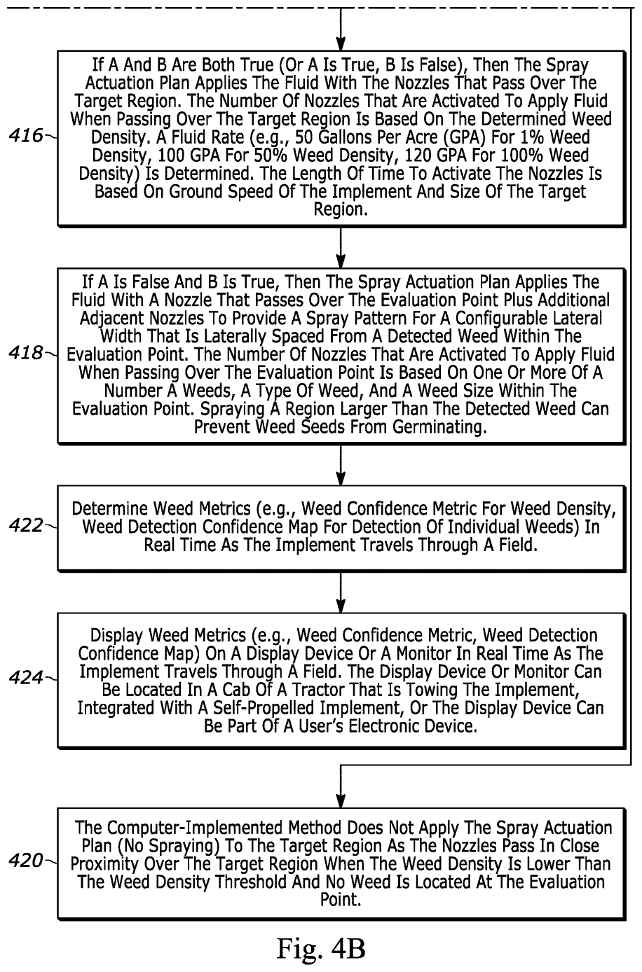

FIGS. 4A-4B illustrate a flow diagram of one embodiment for a computer-implemented method of using images captured by a vision based system to apply fluids (e.g., fertilizer, herbicide, insecticide, and/or fungicide, etc.) in a targeted manner to fields. The vision based system (e.g., system 1070, 1170) includes one or more cameras that are disposed an agricultural implement that is traveling through a field for an application pass. The agricultural implement can be moving through the field in parallel with rows of plants. The method 400 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 400 is performed by processing logic (e.g., processing logic 126) of a processing system, of a camera, or of a monitor (e.g., monitor 1000). The camera can be attached to a boom or any implement as described herein.

At operation 402, the computer-implemented method initiates a software application for a fluid application. At operation 403, the software application receives fluid inputs (e.g., fertilizer, herbicide, insecticide, and/or fungicide, etc.) for a fluid application from a user (e.g., operator, grower, farmer). The operator can set a sensitivity for spraying. The operator can adjust an amount of risk for the spray actuation. In one example, the operator selects a first option from the software application for using less spray but risks more weeds, or selects a second option to use more spray and risks not saving spray. At operation 404, the software application receives a steering angle from a steering sensor of the implement and receives a ground speed of the implement from a speed sensor (e.g., GPS, RADAR wheel sensor). At operation 406, the camera captures a sequence of images while the implement travels through an agricultural field. In one example, the agricultural implement can be moving through the field in parallel with rows of plants and have numerous spray nozzles for a fluid application. The steering angle will indicate whether the implement is traveling in a straight line or with curvature.

At operation 408, the computer-implemented method determines a weed density for a target region (e.g., 80″ by 80″, 100″ by 100″, 40″ by 40″) based on one or more images of the target region. A plurality of nozzles (e.g., 4 to 20 nozzles) are located on the implement in close proximity to the target region. Cameras capture the one or more images of the target region when the target region is slightly in front (e.g., 5 to 20 ft) of the cameras as the implement passes through the field.

At operation 410, the computer-implemented method determines whether one or more weeds are located at an evaluation point within the target region based on one or more images of the evaluation point. A subset (e.g., 1 to 3 nozzles) of the plurality of nozzles can be located on the implement in close proximity to the evaluation point.

At operation 412, the computer-implemented method determines a spray actuation plan on a per nozzle basis for the target region based on A. whether the weed density for the target region reaches a threshold weed density (e.g., 1% or greater weed density) and B. whether one or more weeds are located at the evaluation point within the target region.

In one example, at operation 414, an OR function is applied to A and B such that if the weed density reaches a threshold weed density for the target region or if one or more weeds are located at the evaluation point then the spray actuation plan is performed on the target region or the evaluation point.

If A and B are both true (or A is true, B is false) at operation 416, then the spray actuation plan applies the fluid with the nozzles that pass over the target region. The number of nozzles that are activated to apply fluid when passing over the target region is based on the determined weed density. A fluid rate (e.g., 50 gallons per acre (GPA) for 1% weed density, 100 GPA for 50% weed density, 120 GPA for 100% weed density) is determined. The length of time to activate the nozzles is based on ground speed of the implement and size of the target region.

If A is false and B is true, then the spray actuation plan applies the fluid with a nozzle that passes over the evaluation point plus additional adjacent nozzles to provide a spray pattern for a configurable lateral width that is laterally spaced from a detected weed within the evaluation point at operation 418. The number of nozzles that are activated to apply fluid when passing over the evaluation point is based on one or more of a number a weeds, a type of weed, and a weed size within the evaluation point. Spraying a region larger than the detected weed can prevent weed seeds from germinating.

At operation 420, the computer-implemented method does not apply the spray actuation plan (no spraying) to the target region as the nozzles pass in close proximity over the target region when the weed density is lower than the weed density threshold and no weed is located at the evaluation point. The method can proceed to operation 422.

At operation 422, the computer-implemented method determines weed metrics (e.g., weed confidence metric for weed density, weed detection confidence map for detection of individual weeds) in real time as the implement travels through a field. At operation 424, the computer-implemented method displays weed metrics (e.g., weed confidence metric, weed detection confidence map) on a display device or a monitor in real time as the implement travels through a field. The display device or monitor can be located in a cab of a tractor that is towing the implement, integrated with a self-propelled implement, or the display device can be part of a user's electronic device. The operations 422 and 424 can occur simultaneously with other operations from the method 800 and occur in real time as the implement travels through the agricultural field.

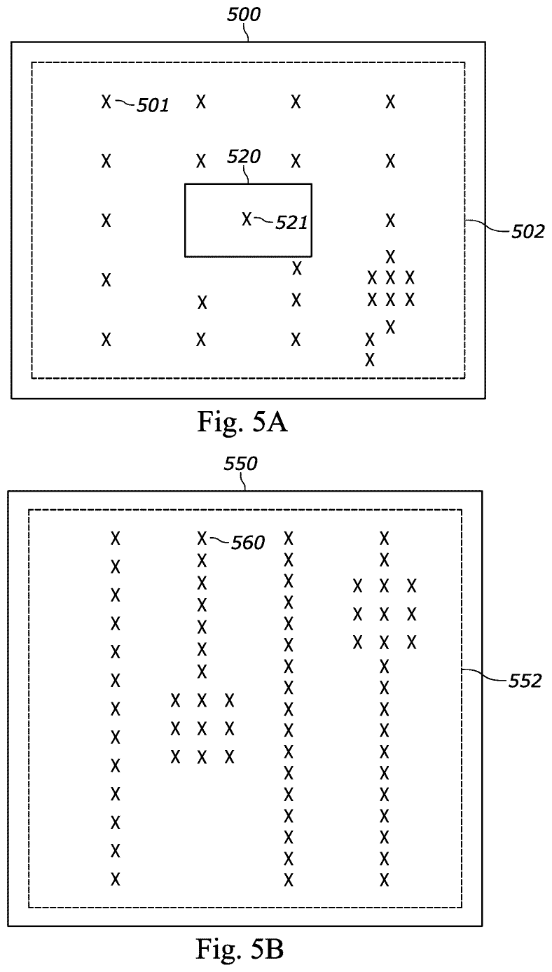

FIGS. 5A-5B show illustrations for displaying maps for weed metrics in accordance with one embodiment. Cameras spaced across a field operation width of an implement capture images that are analyzed to generate metrics and mapping of the metrics with geo-referenced locations in an agricultural field. The cameras are disposed on an implement that is traveled at a known speed through rows of plants in an agricultural field.

The user interfaces (UI) 500 and 550 can display different weed metrics (e.g., weed confidence metric for weed density, weed detection confidence map for detection of individual weeds) on a display device or a monitor in real time as the implement travels through a field. The UI 500 shows weeds 501 in a target region 502 and also an individual weed 521 in an evaluation point 520. In one example, a first nozzle of an implement is aligned above the weed 521. The first nozzle and additional adjacent second and third nozzles will be activated to spray fluid on the weed and nearby the weed for a certain time period to apply the fluid a certain distance (e.g., 1 to 2 feet) before and after the nozzles pass over the weed 521. The UI 550 can display a weed confidence metric for weed density across a larger region 552. Weeds 560 are shown per acre or per unit area in UI 550.

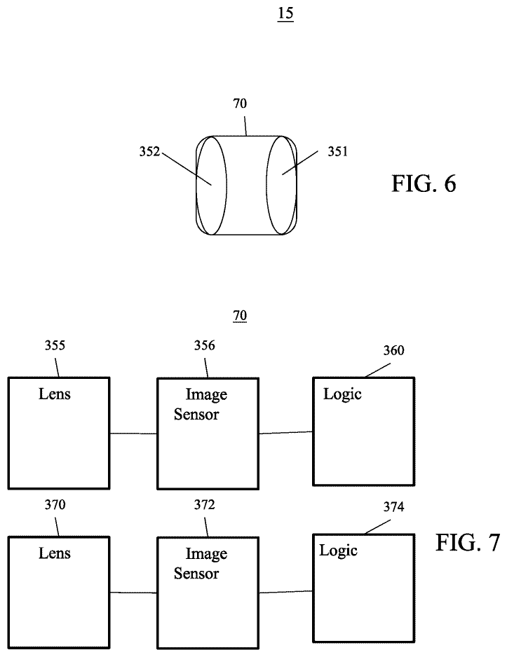

Cameras 70 can be installed at various locations across an implement or boom arm 22. Cameras 70 can have a plurality of lenses. An exemplary camera 70 is illustrated in FIG. 6 with lenses 351 and 352. Each lens 351 and lens 352 can have a different field of view. The different fields of view can be obtained by different focal lengths of the lens. Cameras 70 can be positioned to view spray from nozzles 50 for flow, blockage, or drift, to view for guidance, for obstacle avoidance, to identify plants, to identify weeds, to identify insects, to identify diseases, or combinations thereof.

In a camera system, the image sensor receives incident light (photons) that is focused through a lens or other optics. Depending on whether the sensor is CCD or CMOS, the image sensor will transfer information to the next stage as either a voltage or a digital signal. CMOS sensors convert photons into electrons, then to a voltage, and then into a digital value using an on-chip Analog to Digital Converter (ADC).

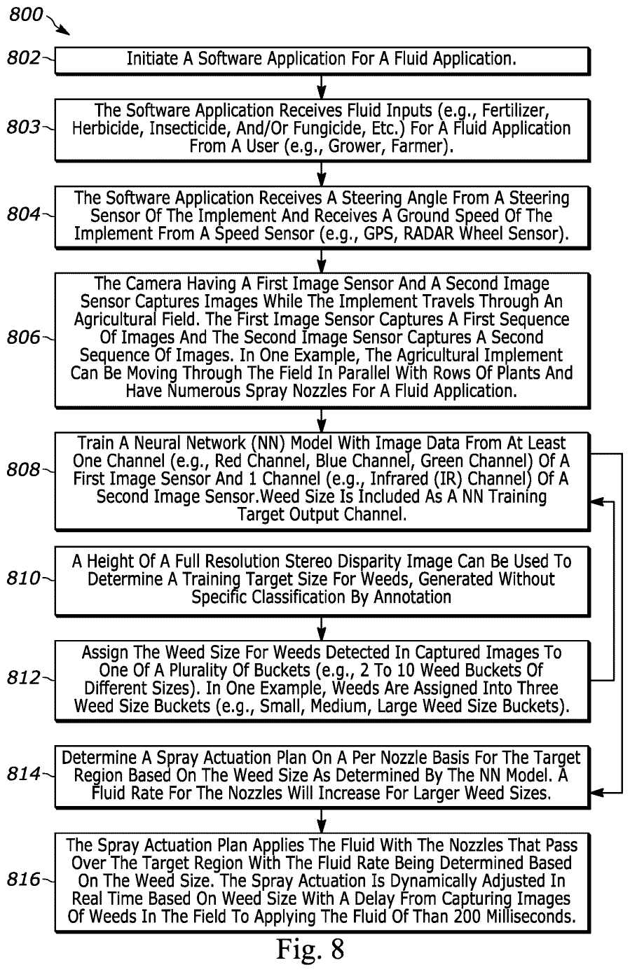

In some embodiments, a camera 70 includes an image sensor 356 for lens 355 and an image sensor 372 for lens 370 of FIG. 7. The sensor 356 is a RGB image sensor with an IR blocking filter. The sensor 356 may have millions of photosites that each represent a pixel of a captured image. Photosites catches the light, but cannot distinguish between the different wavelengths—therefore cannot capture the color. To get a color image, a thin color filter array is placed over the photodiodes. This filter includes RGB blocks of which each is placed on top of the photodiode. Now, each of the RGB blocks can capture the intensity of the RGB. Processing logic (e.g., a processor, a graphics processor, a graphics processing unit (GPU)) of the logic 360 analyzes the color and intensity of each photosite and the processed image data is stored in memory.

In one example, the image sensor 372 has a filter that allows IR light to pass to the image sensor 372. The first and second image sensors have a slight offset from each other. A processor of the logic 374 analyzes the intensity of each photosite and the processed IR image data is stored in memory. In another embodiment, the image sensors 356 and 372 share the same logic.

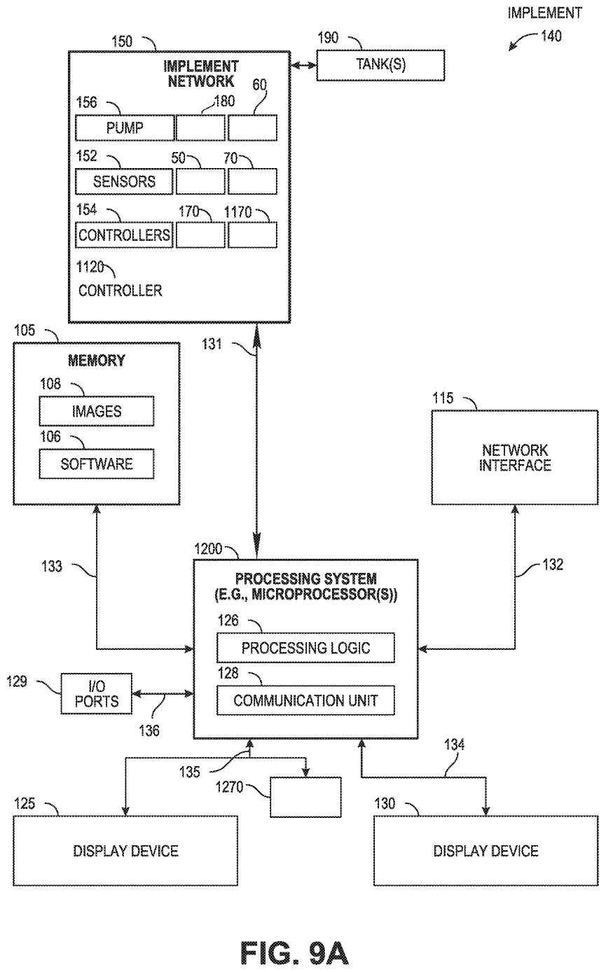

FIG. 8 illustrates a flow diagram of one embodiment for a computer-implemented method of using a neural network (NN) model to determine weed size from images captured by multiple image sensors of a vision based system to apply fluids (e.g., fertilizer, herbicide, insecticide, and/or fungicide, etc.) in a targeted manner to fields. The vision based system (e.g., system 1070, 1170) includes one or more cameras that are disposed an agricultural implement that is traveling through a field for an application pass. The agricultural implement can be moving through the field in parallel with rows of plants. The method 800 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 800 is performed by processing logic (e.g., processing logic 126) of a processing system, of a camera, or of a monitor (e.g., monitor 1000). One or more cameras can be attached across a field operation width of a boom or any implement as described herein.

At operation 802, the computer-implemented method initiates a software application for a fluid application. At operation 803, the software application receives fluid inputs (e.g., fertilizer, herbicide, insecticide, and/or fungicide, etc.) for a fluid application from a user (e.g., operator, grower, farmer). The operator can set a sensitivity for spraying. The operator can adjust an amount of risk for the spray actuation. In one example, the operator selects a first option from the software application for using less spray but risks more weeds, or selects a second option to use more spray and risk not saving spray. At operation 804, the software application receives a steering angle from a steering sensor of the implement and receives a ground speed of the implement from a speed sensor (e.g., GPS, RADAR wheel sensor). At operation 806, the one or more cameras each having a first image sensor and a second image sensor capture images while the implement travels through an agricultural field. The first image sensor captures a first sequence of images and the second image sensor captures a second sequence of images. In one example, the agricultural implement can be moving through the field in parallel with rows of plants and have numerous spray nozzles for a fluid application. The steering angle will indicate whether the implement is traveling in a straight line or with curvature.

At operation 808, the computer-implemented method trains the NN model with image data from 3 RGB channels (e.g., red channel, blue channel, green channel) of a first image sensor and 1 channel (e.g., infrared (IR) channel) of a second image sensor for each camera. Weed size is provided as a NN training target output channel. Offsets will exist between images captured with the 3 RGB channels from the first image sensor and 1 channel from the second image sensor and will be part of the training of the NN model. At operation 810, stereo disparity data (e.g., full resolution stereo disparity data) between the first image sensor and the second image sensor of a camera is used to determine an approximate weed size for weeds. The weed size is an input for the NN model during training at operation 808. A height of a full resolution (e.g., 4K resolution) stereo disparity image can be used to determine a training target size for weeds, generated without specific classification by annotation. Annotators do not assign a weed size to weeds during training. At operation 812, the computer-implemented method assigns the weed size for weeds detected in captured images to one of a plurality of buckets (e.g., 2 to 10 weed buckets of different sizes). In one example, weeds are assigned into three weed size buckets (e.g., small, medium, large weed size buckets) for the training of operation 808. Annotators can assign a weed size to weeds during annotation.

The stereo disparity data is determined during a stereo calibration between the first and second image sensors of a camera. The stereo calibration determines a rotation and translation between the first and second image sensors. The stereo calibration is described in co-pending Application No. 63/386,201, filed 6 Dec. 2022. As described in co-pending Application No. 63/386,201, a registration (alignment) matrix is determined to align a second raw image (e.g., left raw image) from the second image sensor with the disparity warped first image (e.g., right image) based on intrinsic camera parameters (e.g., focal length of lens, pixel spacing on lens). The resultant registration (i.e., essential or homography) matrix is the stereo calibration matrix for images (e.g., left images) from the second image sensor.

A plurality of nozzles (e.g., 4 to 20 nozzles) are located on the implement in close proximity to a target region. Cameras capture the one or more images of the target region when the target region is slightly in front (e.g., 5 to 20 ft) of the cameras as the implement passes through the field.

At operation 814, the computer-implemented method determines a spray actuation plan on a per nozzle basis for the target region based on the weed size as determined by the NN model. A fluid rate for the nozzles will increase for larger weed sizes.

At operation 816, the spray actuation plan applies the fluid with the nozzles that pass over the target region with the fluid rate being determined based on the weed size. The spray actuation is dynamically adjusted in real time based on weed size with a delay from capturing images of weeds in the field to applying the fluid of than 200 milliseconds. The delay is based on shutter speed of the cameras, image capturing time, preprocessing and processing of the image data, and post processing to actuate the nozzles for spraying the fluid onto the detected weeds.

The spray actuation as described herein in this present application can be adjusted to spray regardless of a changing spray threshold (e.g., threshold weed density, detected weed in evaluation point, weed size, etc.) required to spray based on conditions such a shadow, dust on lens, dust in air, boom height, boom stability, and ambient light. In other words, even if a spray threshold is not reached indicating no spray, if a certain condition (e.g., a shadow, dust on lens, dust in air, boom height, boom stability, and ambient light) occurs then spray actuation will be triggered.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

Cameras 70 can be connected to a display device or a monitor 1000, such as the monitor disclosed in U.S. Pat. No. 8,078,367. Camera 70, display device, processing system, or monitor 1000 can each process the images captured by camera 70 or share the processing of the images. In one embodiment, the images captured by camera 70 can be processed in camera 70 and the processed images can be sent to monitor 1000. In another embodiment, the images can be sent to monitor 1000 for processing. Processed images can be used to identify flow, to identify blockage, to identify drift, to view for guidance, for obstacle avoidance, to identify plants, to identify weeds, to identify insects, to identify diseases, or combinations thereof. Once identified, monitor 1000 can alert an operator of the condition and/or send a signal to a device to address the identified condition, such as to a nozzle 50 to activate to apply herbicide to a weed.

FIG. 9A shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 9A. The I/O ports 129 (e.g., diagnostic/on board diagnostic (OBD) port) enable communication with another data processing system or device (e.g., display devices, sensors, etc.).

In one example, the self-propelled implement 140 performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as fluid application software for analysis of fluid applications for performing operations of the present disclosure, or any other software application or module, images (e.g., captured images of crops and weeds, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed metrics, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50and vision guidance system 1170 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 9B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (POE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 11B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., weed metrics, planting data, GPS data, liquid application data, flow rates, calibration data for camera calibrations, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed metrics, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e. g, Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50vision guidance system 1170 having cameras and processors, and autosteer controller 1120 for various embodiments of this present disclosure. The autosteer controller 1120 may also be part of the machine network 110 instead of being located on the implement network 150 or in addition to being located on the implement network 150.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 9B.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one embodiment, a machine-accessible non-transitory medium (e.g., memory 105) contains executable computer program instructions which when executed by a data processing system cause the system to perform operations or methods of the present disclosure

It will be appreciated that additional components, not shown, may also be part of the system in certain embodiments, and in certain embodiments fewer components than shown in FIG. 9A and FIG. 9B may also be used in a data processing system. It will be appreciated that one or more buses, not shown, may be used to interconnect the various components as is well known in the art.

Examples—The following are non-limiting examples.
Example 1—a system comprising a boom, a plurality of nozzles disposed along the boom to apply a fluid application as the boom travels through an agricultural field, at least one camera disposed on the boom to capture images of the agricultural field including a target region, and a processor communicatively coupled to the at least one camera. The processor is configured to determine a weed density for the target region and whether one or more weeds are located at an evaluation point within the target region based on one or more images of the target region, and to determine a spray actuation plan on a per nozzle basis for the target region based on whether the weed density for the target region equals or exceeds a threshold weed density and whether one or more weeds are located at the evaluation point within the target region.
Example 2—the system of Example 1, wherein the processor is further configured to perform the spray actuation plan if the weed density equals or exceeds the threshold weed density for the target region or if one or more weeds are located at the evaluation point.
Example 3—the system of any preceding Example, wherein the processor is further configured to perform the spray actuation plan by applying fluid with the nozzles that pass over the target region when the weed density reaches a threshold weed density for the target region.
Example 4—the system of any preceding Example, wherein the processor is further configured to perform the spray actuation plan and determine a number of nozzles to apply fluid when passing over the target region based on the determined weed density.
Example 5—the system of any preceding Example, wherein the processor is further configured to perform the spray actuation plan and determine a first fluid rate for a minimum first weed density, a second fluid rate for a second weed density, and a third fluid rate for a third weed density.
Example 6—the system of any preceding Example, wherein the processor is further configured to perform the spray actuation plan when the weed density is below the threshold weed density and detection of one or more weeds at an evaluation point.
Example 7—the system of any preceding Example, wherein the spray actuation plan to cause application of the fluid with a nozzle that passes over the evaluation point plus additional adjacent nozzles to provide a spray pattern for a configurable lateral width that is laterally spaced from the one or more weeds within the evaluation point.
Example 8—the system of any preceding Example, wherein a number of nozzles that are activated to apply fluid when passing over the evaluation point is based on one or more of a number a weeds, a type of weed, and a weed size within the evaluation point.
Example 9—the system of any preceding Example, wherein the processor is further configured to determine a weed confidence metric for weed density and a weed detection confidence map for detection of individual weeds in real time as the boom travels through a field.
Example 10—the system of any preceding Example, further comprising a display device coupled to the processor. The display device is configured to display a weed confidence metric and weed detection confidence map.
Example 11—a computer-implemented method, comprising initiating a software application for a fluid application of an implement, receiving a sequence of images that are captured with a camera disposed on the implement while the implement travels through an agricultural field, determining a weed density for a target region based on one or more captured images of the target region, determining whether one or more weeds are located at an evaluation point within the target region based on one or more images of the evaluation point, and determining a spray actuation plan on a per nozzle basis for the target region based on whether the weed density for the target region reaches a threshold weed density and whether one or more weeds are located at the evaluation point within the target region.
Example 12—the computer-implemented method of Example 11, further comprising performing the spray actuation plan if the weed density reaches a threshold weed density for the target region or if one or more weeds are located at the evaluation point.
Example 13—the computer-implemented method of any preceding Example, further comprising performing the spray actuation plan by applying fluid with the nozzles that pass over the target region when the weed density equals or exceeds the threshold weed density for the target region.
Example 14—the computer-implemented method of any preceding Example, further comprising performing the spray actuation plan and determining a number of nozzles to apply fluid when passing over the target region based on the determined weed density.
Example 15—the computer-implemented method of any preceding Example, further comprising performing the spray actuation plan and determining a first fluid rate for a minimum first weed density, a second fluid rate for a second weed density, and a third fluid rate for a third weed density.
Example 16—the computer-implemented method of any preceding Example, wherein the processor is further configured to perform the spray actuation plan when the weed density is below the threshold weed density and detection of one or more weeds at an evaluation point.
Example 17—the computer-implemented method of any preceding Example, wherein the spray actuation plan to cause application of the fluid with a nozzle that passes over the evaluation point plus additional adjacent nozzles to provide a spray pattern for a configurable lateral width that is laterally spaced from the one or more weeds within the evaluation point.
Example 18—the computer-implemented method of any preceding Example, wherein a number of nozzles that are activated to apply fluid when passing over the evaluation point is based on one or more of a number a weeds, a type of weed, and a weed size within the evaluation point.
Example 19—the computer-implemented method of any preceding Example, further comprising determining a weed confidence metric for weed density and a weed detection confidence map for detection of individual weeds in real time as the implement travels through a field in parallel with rows of plants.
Example 20—the computer-implemented method of any preceding Example, further comprising displaying a weed confidence metric for weed density and a weed detection confidence map for detection of individual weeds in real time as the implement travels through a field in parallel with rows of plants.
Example 21—a computer implemented method comprising capturing, with a first image sensor of a camera that is disposed on an implement, a first sequence of images while the implement travels through an agricultural field, capturing, with a second image sensor of the camera, a second sequence of images while the implement travels through the agricultural field, training a neural network (NN) model with image data from at least one channel of the first image sensor and one channel of the second image sensor, and including weed size as NN training target output channel.
Example 22—the computer-implemented method of Example 21, wherein the NN model is trained with image data from a red channel, a blue channel, and a green channel of the first image sensor and one infrared (IR) channel of the second image sensor.
Example 23—the computer-implemented method of any of Examples 21-22, further comprising providing the weed size as an input for the NN model during training.
Example 24—the computer-implemented method of any of Examples 21-23, wherein a height of a full resolution stereo disparity image is used to determine a training target for weeds, generated without specific classification by annotation.
Example 25—the computer-implemented method of any of Examples 21-24, wherein the weed size is determined by annotators assigning a weed size to weeds during annotation.
Example 26—the computer-implemented method of any of Examples 21-25, further comprising assigning the weed size for each weed detected in captured images to one of a plurality of buckets for two or more weed buckets of different sizes.
Example 27—the computer-implemented method of any of Examples 21-26, further comprising determining a spray actuation plan on a per nozzle basis for the target region based on the weed size as determined by the NN model.
Example 28—the computer-implemented method of any of Examples 21-27, further comprising applying based on the spray actuation plan fluid from a fluid source to nozzles of the implement that pass over a target region with a fluid rate being determined based on the weed size.
Example 29—the computer-implemented method of any of Examples 21-28, wherein the spray actuation of the nozzle is dynamically adjusted in real time based on weed size.
Example 30—the computer-implemented method of any of Examples 21-29, wherein the camera is disposed to look ahead in a direction of travel of the implement or to look downwards.
Example 31—a system comprising an agricultural implement, a camera having a first image sensor and a second image sensor that is disposed on the agricultural implement. The camera is configured to capture a first sequence of images with the first image sensor while the implement travels through an agricultural field and configured to capture a second sequence of images with the second image sensor while the implement travels through the agricultural field. Processing logic is configured to train a neural network (NN) model with image data from at least one channel of the first image sensor and one channel of the second image sensor and to include weed size as NN training target output channel.
Example 32—the system of Example 31, wherein the NN model is trained with image data from the at least one channel including a red channel, a blue channel, and a green channel of the first image sensor and the one channel including an infrared (IR) channel of the second image sensor.
Example 33—the system of any of Examples 31-32, wherein the processing logic is configured to provide the weed size as an input for the NN model during training.
Example 34—the system of any of Examples 31-33, wherein a height of a full resolution stereo disparity image is used to determine a training target size for weeds, generated without specific classification by annotation.
Example 35—the system of any of Examples 31-34, wherein the weed size is determined by annotators assigning a weed size to weeds during annotation.
Example 36—the system of any of Examples 31-35, wherein the processing logic is configured to assign the weed size for each weed detected in captured images to one of a plurality of buckets for two or more weed buckets of different sizes.
Example 37—the system of any of Examples 31-36, wherein the processing logic is configured to determine a spray actuation plan on a per nozzle basis for the target region based on the weed size as determined by the NN model.
Example 38—the system of any of Examples 31-37, further comprising a plurality of nozzles disposed on the agricultural implement to apply fluid based on the spray actuation plan from a fluid source to a target region of the agricultural field as the plurality of nozzles pass over the target region with a fluid rate being determined based on the weed size.
Example 39—the system of any of Examples 31-38, wherein spray actuation of a nozzle of the plurality of nozzles is dynamically adjusted in real time based on weed size.
Example 40—the system of any of Examples 31-39, wherein the camera is disposed to look ahead in a direction of travel of the implement or to look downwards.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A computer implemented method comprising:
capturing, with a first image sensor of a camera that is disposed on an implement, a first sequence of images while the implement travels through an agricultural field;
capturing, with a second image sensor of the camera, a second sequence of images while the implement travels through the agricultural field;
training a neural network (NN) model with image data from at least one channel of the first image sensor and one channel of the second image sensor; and
providing weed size as NN training target output channel.

2. The computer implemented method of claim 1, wherein the NN model is trained with image data from a red channel, a blue channel, and a green channel of the first image sensor and one infrared (IR) channel of the second image sensor.

3. The computer implemented method of claim 1, further comprising:
providing the weed size as an input for the NN model during training.

4. The computer implemented method of claim 1, wherein a height of a full resolution stereo disparity image is used to determine a training target size for weeds, generated without specific classification by annotation.

5. The computer implemented method of claim 1, wherein the weed size is determined by annotators assigning a weed size to weeds during annotation.

6. The computer implemented method of claim 1, further comprising:
assigning the weed size for each weed detected in captured images to one of a plurality of buckets for two or more weed buckets of different sizes.

7. The computer implemented method of claim 1, further comprising:
determining a spray actuation plan on a per nozzle basis for the target region based on the weed size as determined by the NN model.

8. The computer implemented method of claim 1, further comprising:
applying based on the spray actuation plan fluid from a fluid source to nozzles of the implement that pass over a target region with a fluid rate being determined based on the weed size.

9. The computer implemented method of claim 1, wherein the spray actuation of the nozzle is dynamically adjusted in real time based on weed size.

10. The computer implemented method of claim 1, wherein the camera is disposed to look ahead in a direction of travel of the implement or to look downwards.

11. A system comprising:
an agricultural implement;
a camera having a first image sensor and a second image sensor is disposed on the agricultural implement, the camera is configured to capture a first sequence of images with the first image sensor while the implement travels through an agricultural field and configured to capture a second sequence of images with the second image sensor while the implement travels through the agricultural field; and
processing logic that is configured to train a neural network (NN) model with image data from at least one channel of the first image sensor and one channel of the second image sensor and to utilize stereo disparity data between the first image sensor and the second image sensor to determine an approximate weed size for weeds in the captured first and second sequences of images.

12. The system of claim 11, wherein the NN model is trained with image data from the at least one channel including a red channel, a blue channel, and a green channel of the first image sensor and the one channel including an infrared (IR) channel of the second image sensor.

13. The system of claim 11, wherein the processing logic is configured to provide the weed size as an input for the NN model during training.

14. The system of claim 11, wherein a height of a full resolution stereo disparity image is used to determine a training target size for weeds, without size input from annotation.

15. The system of claim 11, wherein the weed size is determined by annotators assigning a weed size to weeds during annotation.

16. The system of claim 11, wherein the processing logic is configured to assign the weed size for each weed detected in captured images to one of a plurality of buckets for two or more weed buckets of different sizes.

17. The system of claim 11, wherein the processing logic is configured to determine a spray actuation plan on a per nozzle basis for the target region based on the weed size as determined by the NN model.

18. The system of claim 17, further comprising:
a plurality of nozzles disposed on the agricultural implement to apply fluid based on the spray actuation plan from a fluid source to a target region of the agricultural field as the plurality of nozzles pass over the target region with a fluid rate being determined based on the weed size.

19. The system of claim 18, wherein spray actuation of a nozzle of the plurality of nozzles is dynamically adjusted in real time based on weed size.

20. The system of claim 1, wherein the camera is disposed to look ahead in a direction of travel of the implement or to look downwards.
